(19) United States
(12) Patent Application Publication
(10) Pub. No.: US 2025/0328599 A1
(43) Pub. Date: Oct. 23, 2025

(54) Rejection Sampling For Polynomial Coefficient Generator

(71) Applicant: Microsoft Technology Licensing, LLC, Redmond, WA (US)

(72) Inventors: Mojtaba BISHEH NIASAR, Dover, NH (US); Bryan David KELLY, Carnation, WA (US); Bharat S. PILLILLI, El Dorado Hills, CA (US)

(21) Appl. No.: 18/637,989

(22) Filed: Apr. 17, 2024

(51) Int. Cl. G06F 17/11; G06F 7/58

(52) U.S. Cl. CPC G06F 17/11; G06F 7/588

(57) ABSTRACT

A polynomial coefficient generator includes a random number generator to generate a random bit string. A buffer is coupled to receive bits of the random bit string and a rejection sampler is coupled to the buffer to receive n+1 sets of p bits of buffered bits of the random bit string, where n is an integer having a value of at least four, and sample each set of n bits in parallel to identify valid sets of p bits A valid coefficient queue is coupled to receive the valid sets of p bits, and a polynomial multiplier is coupled to receive the valid sets of p bits from the valid coefficient queue. A method uses the generator to generate valid coefficients.

### BACKGROUND

The advent of quantum computers poses a serious challenge to the security of the existing public-key cryptosystems, as they can be potentially broken based on Shor's algorithm. Lattice-based cryptosystems are among the most promising PQC algorithms that are believed to be hard for both classical and quantum computers.

Number Theoretic Transform (NTT) and inverse Number Theoretic Transform (INTT) are used to achieve more efficient polynomial multiplication in lattice-based cryptosystems by reducing time-complexity from O(n²) to O(n log n).

Rejection sampling of polynomial coefficients is used to generate a random polynomial from a uniform distribution and check if each coefficient of the polynomial satisfies certain conditions. The rejection of some coefficients can lead to inefficiencies and time delays in polynomial generation.

### SUMMARY

A polynomial coefficient generator includes a random number generator to generate a random bit string. A buffer is coupled to receive bits of the random bit string and a rejection sampler is coupled to the buffer to receive n+1 sets of p bits of buffered bits of the random bit string, where n is an integer having a value of at least four, and sample each set of n bits in parallel to identify valid sets of p bits A valid coefficient queue is coupled to receive the valid sets of p bits, and a polynomial multiplier is coupled to receive the valid sets of p bits from the valid coefficient queue.

A method includes receiving a random bit string, selecting n+1 sets of p bits of the random bit string, where n is an integer having a value of at least four, rejection sampling each set of p bits in parallel to identify valid sets of p bits, storing the valid sets of p bits in a queue, and providing n sets of p bits of the stored valid sets of p bits from the queue to a polynomial multiplier.

### BRIEF DESCRIPTION OF THE DRAWINGS

FIG. 1 is a block diagram of a portion of an improved lattice based cryptographic system related to rejection sampling according to an example embodiment.

FIG. 2 is a block diagram illustrating details of an example rejection sampler according to an example embodiment.

FIG. 3 is a block circuit diagram of rejection checker according to an example embodiment.

FIG. 4 is a table showing a status of a queue during cycles of coefficient processing by the rejection sampler according to an example embodiment.

FIG. 5 is a flowchart illustrating a method of validity checking coefficients according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

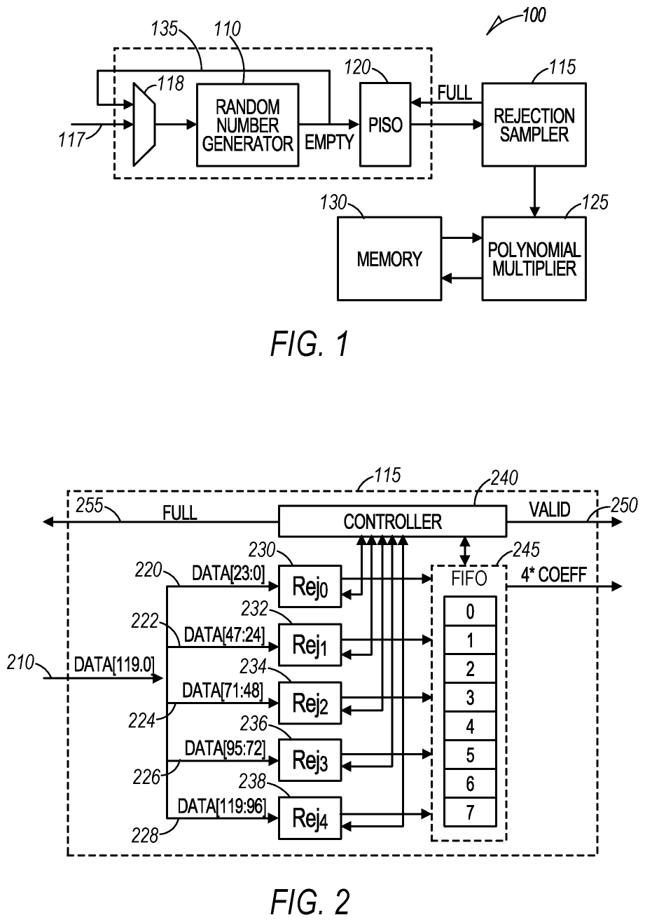

Rejection sampling is used to generate random coefficients from a uniform distribution and check if each coefficient of the polynomial satisfies certain conditions. The random coefficients are for a lattice-based cryptosystem polynomial. FIG. 1 is a block diagram of a portion of an improved lattice based cryptographic system 100 related to rejection sampling. System 100 may utilize Dilithium (or Kyber) based cryptographic algorithms.

A random number generator 110 is used to generate random bit strings from which polynomial coefficients are obtained and check for compliance via a rejection sampler 115. System 100 has an architecture that can balance between throughput of the random number generator 110 and the rejection sampler 115.

The rejection sampler 115 samples polynomial coefficients that make up vectors and matrices used in the lattice-based polynomials. The random number generator generates the random bitstring based on a fixed seed value and a nonce value input at 117 provided as input to the random number generator 110 via a multiplexor 118. The random number generator 110 may be a Keccak random number generator 110.

The random bit string may be stored in a parallel-in-serial-out (PISO) buffer 120. The random number generator 110 in one example requires 12 cycles to generate 1344 bits and cannot produce an output in one cycle. In one example, the rejection sampler 115 takes 24-bits (12 bits in case of Kyber) of the bit string generated by random number generator 110. Such bits are referred to as a candidate coefficient. The rejection sampler 115 checks to determine if the candidate coefficient is greater than or equal to a prime number q such as q=2²³−2¹³+1=8380417 (q=3369 in case of Kyber). If smaller, the candidate bit string is found to be valid. The rejection sampler 115 continues to sample for all coefficients, n=256, for the polynomial from the buffer 120 using several cycles of random number generation.

Valid candidate coefficients are provided to a polynomial multiplier 125 and may be stored in a memory 130. As the buffer 120 is emptied of random bits by the rejection sampler 115 during rejection sampling of candidate coefficients for one polynomial, the nonce value may be provided back to the random number generator 110 via a feedback loop path 135 to fill buffer 120 with further random numbers until a new nonce value is needed for a next polynomial. The nonce is updated only after all 256 required coefficients have been sampled. Keccak possesses the ability to generate an unlimited bit stream using the same seed and nonce, achieved through the loop path 135 on multiplexer 118. When buffer 120 becomes empty, the random number generator 110 performs a new round of random number generation (continuing the bitstream with the same seed/nonce) that is delivered into the buffer 120.

After sampling a polynomial with 256 coefficients, the nonce value will be changed and a new random bit string will be generated using random number generator 110 and will be sampled by the rejection sampler.

The output of the rejection sampler results in a matrix of polynomial coefficients with k rows and 1 columns while each polynomial includes 256 coefficients.

$${[ \begin{matrix}{A}_{0 , 0} & … & {A}_{0 , l - 1} \\ ⋮ & ⋱ & ⋮ \\ {A}_{k - 1 , 0} & … & {A}_{k - 1 , l - 1}\end{matrix} ]}_{k \times l}$$

The values of k and l may be determined based on a desired security level of the system, which is defined by the National Institute of Standards and Technology (NIST) as follows:

| Algorithm Name | Security Level | K | 1 |
|---|---|---|---|
| ML-DSA-44 | Level-2 | 4 | 4 |
| ML-DSA-65 | Level-3 | 6 | 5 |
| ML-DSA-87 | Level-5 | 8 | 7 |

Rejection sampling is used in all three operations for module-lattice-based digital signatures (ML-DSA), including key generation, signature generation, and verification of signatures, referred respectively as keygen, sign, and verify. Since the coefficients are generated based on the specification of the Dilithium (and Kyber), the sampled coefficients are considered in number theoretic transform (NTT) domain, the output of rejection sampler can directly be used for polynomial multiplication operations of polynomial multiplier 125, as follows:

$$[ \begin{matrix}{A}_{0 , 0} & … & {A}_{0 , l - 1} \\ ⋮ & ⋱ & ⋮ \\ {A}_{k - 1 , 0} & … & {A}_{k - 1 , l - 1}\end{matrix} ] ∘ [ \begin{matrix}{S}_{1 , 0} \\ ⋮ \\ {S}_{1 , l - 1}\end{matrix} ] = [ \begin{matrix}{A}_{0 , 0} ° {S}_{1 , 0} + … + {A}_{0 , l - 1} ° {S}_{1 , l - 1} \\ ⋮ \\ {A}_{k - 1 , 0} ° {S}_{1 , 0} + … + {A}_{k - 1 , l - 1} ° {S}_{1 , l - 1}\end{matrix} ]$$

where s is secret key stored into memory 130. In each cycle, one line of memory 130 that contains 4 coefficients of s is read and multiplication is performed between these 4 s coefficients with 4 coefficients, A, obtained from rejection sampler using polynomial multiplier 125. The results will be stored into memory 130. This is continued for all coefficients.

The architecture of system 100 may be used remove or reduce the cost of memory access from the random number generator 110 to the rejection sampler 115, and from rejection sampler to the polynomial multiplier 125. The need for large buffers is avoided by balancing throughput and removing memory access conflicts between each of the random number generator 110, rejection sampler 115, and polynomial multiplier 125.

In one example, random number generator 110 is a Keccak random number generator used in a SHAKE-128 configuration for rejection sampling operations. The random number generator 110 takes the input 117 data and generates 1344-bit output after each round. In one example, each round of successful polynomial coefficient generation takes 12 cycles. The format of input data is as follows:

$$\text{Input data} = ρ \vert j \vert i$$

Where ρ is seed with 256-bits, i and j are nonce that describes the row and column number of corresponding polynomial A such that:

$${A}_{i , j} = Rejection\_sampling ( Keccak ( ρ \vert j \vert i ) )$$

Since 24-bits is used for one coefficient, each round of Keccak output provides 1344/24=56 coefficients. To have 256 coefficients for each polynomial (with same seed and nonce), the random number generator 110, Keccak, is run for at least 5 rounds.

There are two paths for random number generator 110 input. While the input 117 can be set by a controller (see FIG. 2) for each new polynomial, the loop path 135 is used to rerun the random number generator 110 for completing the previous polynomial. Multiplexor 118 may be controlled to provide the input from loop path 135 for the sample polynomial, or from input 117 for a new polynomial.

Rejection sampler 115 cannot take all 1344-bit output parallelly as it would result in a hardware architecture that is too costly and complex. Following provision of the input 117, no other output will be generated by the random number generator 110 for use by the rejection sampler 115 for the next 12 cycles. The PISO buffer 120 is used between the rejection sampler 115 and random number generator 110 to store the random number generator 110 output and feed the rejection sampler 115 bits sequentially.

FIG. 2 is a block diagram illustrating details of an example rejection sampler 115. In one example, the rejection sampler 115 receives random bits from the PISO buffer 120. A number of cycles used for the rejection sampler 115 may be variable due to the non-deterministic pattern of rejection sampling. In other words, some of the coefficients corresponding to a sequence of random bits obtained from the PISO buffer 120 may be found not valid. At least five rounds of random number generation may be needed to provide 256 coefficients.

The rejection sampler 115 works in parallel with the random number generator 110. Therefore, the latency for rejection sampling is absorbed within the latency of the random number generator 110. One cycle of the rejection sampler 115 operates on 120 bits of the random number from PISO buffer on an input 210. This input corresponds to five candidate coefficients indicated at 220, 222, 224, 226, and 228 which are respectively processed by five rejection samplers or checkers 230, 232, 234, 236, and 238 operating under control of a controller 240.

Each rejection checker 230, 232, 234, 236, and 238 may be a circuit that checks the candidate coefficient it receives to determine if the candidate meets selected criteria. If met, a candidate coefficient becomes a valid coefficient and is stored in a queue 245. Controller 240 monitors input and output of the queue 245 to determine whether or not the queue is full, or there is a sufficient number of valid coefficients stored in the queue 245 for further operation by polynomial multiplier 125, which in one example requires four valid coefficients to proceed.

The polynomial multiplier 125, in one example, can perform point-wise multiplication on four coefficients per cycle. This implies that the optimal speed of the rejection sampler 115 is to sample four coefficients without rejection in one cycle.

On the output side, as a rejection sampling might fail, the rejection rate for each input is:

$$rejection\_rate = 1 - \frac{q}{{2}^{23}} = 1 - \frac{8380471}{{2}^{23}} = 0.0009764 \approx 1 {0}^{- 3}$$

Hence, the probability of failure to provide 4 appropriate coefficients from 4 inputs would be:

$$1 - {( 1 - rejection\_rate )}^{4} = 0.00399$$

To reduce the failure probability and avoid any wait cycle in polynomial multiplication, five coefficients are processed at a time by the rejection checkers, greatly increasing the odds that four valid coefficients will be stored in the queue 245 and available to be passed to polynomial multiplier 125. Checking five coefficients reduces the probability of failure to

$$1 - ( probability of having 5 good inputs ) - ( probability of having 4 good inputs ) = 1 - {( 1 - {rejection}_{rate} )}^{5} - {rejection}_{rate} * ( \begin{matrix}5 \\ 4\end{matrix} ) {( 1 - {rejection}_{rate} )}^{4} = 0.00000998 \approx 1 {0}^{- 5}$$

Adding the queue 245 as a first-in-first-out (FIFO) queue to the rejection sampler 115 allows the storing of remaining unused coefficients and further increases the probability of having at least four valid coefficients to match the polynomial multiplier 125 throughput. In one example queue 245 can hold up to eight valid coefficients.

Input to the rejection sampler comprises five candidate coefficients. Each candidate is one of five contiguous 24 bit chunks of the bit string. The five rejection sampler circuits each receive one of the candidate coefficeints and process the candidate in parallel. The controller 240 checks if candidate coefficients should be rejected or not. The valid candidate coefficients can be stored into the queue 245. While a maximum of five valid coefficients can be fed into queue 245, there are three more entries for the remaining coefficients from one or more previous cycles. There are several scenarios for checking and providing valid coefficients.

At the very first cycle, or whenever the queue 245 is empty, the use of four rejection checkers may not provide all four coefficients for polynomial multiplication unit. The failure probability of this scenario is reduced by feeding 5 coefficients and checking five coefficients by rejection checkers 230, 232, 234, 236, and 238. The controller tracks the number of valid coefficients in the queue 245 and provides a VALID output 250 that stops polynomial multiplier 125 until all four required coefficients are sampled, at which point the polynomial multiplier accesses the queue 245 to obtain the oldest four coefficients.

If all five inputs are valid, they are going to be stored into the queue 245. The first four coefficients will be sent to or obtained by polynomial multiplier 125, while the remaining coefficients will be shifted to a head of the queue 245 and used for the next cycle with the first 3 valid coefficients from the next cycle.

In one example, a maximum depth of the queue 245 is eight entries. If all eight FIFO entries are full, the oldest four valid coefficients will be provided for the next cycle without the need for the random number generator to deliver the next 120 bits of the bit string. The controller 240 may inform the buffers 120 to wait by raising a FULL flag at 255.

If the FULL flag is not raised, all PISO buffer 120 data can be read in 12 cycles, including 11 cycles with five coefficients and one cycle for the 56th coefficient. This would match with the random number generator 110 throughput that generates 56 coefficients per 12 cycles.

The maximum number of FULL conditions is when there are no rejected coefficients for all 56 candidate coefficients. In this case, after four cycles with five coefficients, there is one FULL condition. After 12 cycles, 50 coefficients are processed by rejection checkers, and there are still 6 coefficients inside the PISO buffer 120. To maximize the utilization factor of hardware resources, the random number generator 110 will check the PISO buffer 120 status. If the PISO buffer 120 contains five coefficients or more (the required inputs for rejection sampling unit), an EMPTY flag will not be set, and the random number generator 110 will wait until the next cycle. Hence, rejection sampling checkers takes 13 cycles to process 55 coefficients, and the last coefficients will be combined with the next random number generator round to be processed.

Each round of random numbers using rejection sampling uses 12 to 13 cycles that result in 60-65 cycles for each polynomial with 256 coefficients assuming five rounds of random number generation is sufficient.

For a complete rejection sampling for Dilithium ML-DSA-87 with 8*7=56 polynomials, 3360 to 3640 cycles are used in sequential operation. In one example, system 100 can be duplicated to enable parallel sampling for two different polynomials. Having two parallel design results in 1680 to 1820 cycles, while three parallel design results in 1120 to 1214 cycles at the cost of more resource utilization.

In various example, system 100 can be mapped to FPGA and ASIC platforms to provide a highly efficient post quantum computing cryptographic system.

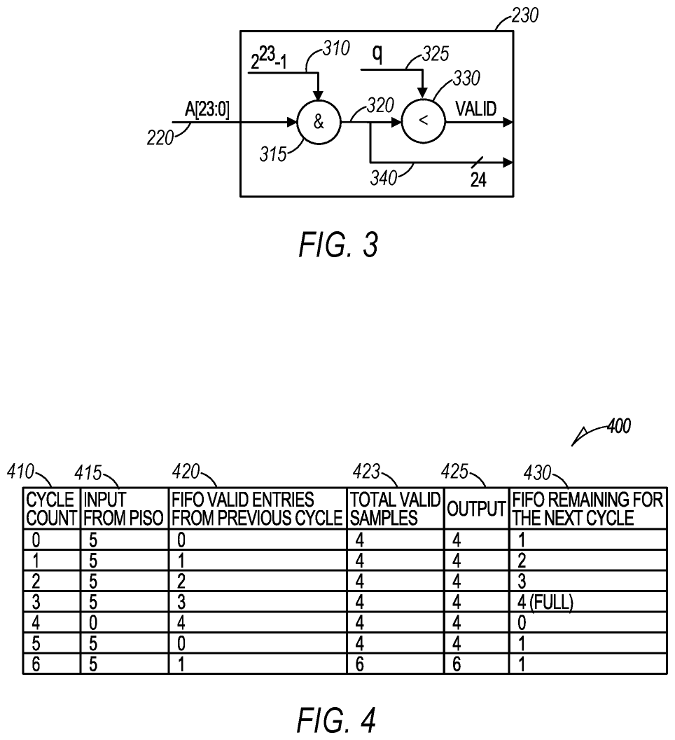

FIG. 3 is a block circuit diagram of rejection checker 230. The diagram is also representative of rejection checkers 232, 234, 236, and 238. Rejection checker 230 receives a candidate coefficient, a [23:0], at 220 and performs a bitwise AND operation 315 with 2²³-1 shown at 310 to mask the most significant bit of the input. The resulting value at 320 is then compared with the prime number q such as q=2²³−2¹³+1=8380417 (q=3369 in case of Kyber) at a compare unit 330 to determine if the value is less than q. If less than q, a valid flag is raised at 335, and the value is provided as output 340.

FIG. 4 is a table 400 showing a status of queue 245 during cycles of coefficient processing by the rejection sampler 115. Table 400 incudes a cycle count column 410, a column 415 representing the number of coefficients received during a cycle from the PISO buffer 120. Column 420 shows a number of FIFO buffer 120 valid entries in the queue 245 at the start of the cycle. Column 423 shows the number of valid samples. Column 425 represents the number of coefficients output by the queue 245 during a cycle, and a column 430 represents the number of valid coefficients remaining the queue 245 following output of the queue 245 at the end of the cycle.

Table 400 shows 6 cycles where all coefficients were found to be valid. This is the most likely scenario given the above described odds of finding an invalid coefficient. In a first cycle, 0, five coefficients were received (column 415) and found valid (column 420.) The queue output (column 425) was four, leaving one valid coefficient (column 430) at the end of the first cycle. A similar input and output were processed in the second and third cycles, cycle count 1 and 2, respectively, with the valid entries count increasing by one each cycle such that three valid coefficients remain at the end of the third cycle as indicated in column 430.

At the start of the fourth cycle, cycle count 3, the number of valid entries or coefficients rises to eight in column 440. This results in the FULL flag being set and four entries remaining at the end of the fourth cycle as indicated in column 430. The FULL flag results in no input from the PISO buffer during the fifth cycle and the remaining four valid entries/coefficient being provided such that the queue 245 is empty at the end of the fifth cycle as indicated in column 430. The sixth cycle is then performed with table entries corresponding to the first cycle due to five entries being received, placed in the queue 245, and four provided as output, leaving one entry remaining at the end of the cycle.

During any of these cycles, at least one candidate coefficient may be found to be not valid. If only one entry is found not valid, the number of valid entries may not increase during that cycle, as four will be provided from the queue 245. In the unlikely event that only three candidates were found valid during a cycle, four coefficients will be provided from the queue if the queue held at least one valid entry from a previous cycle. If less than three candidates were found valid, the queue would have had to have enough valid entries needed make the total available during that cycle be at least four valid entries for providing four valid coefficients at the end of the cycle.

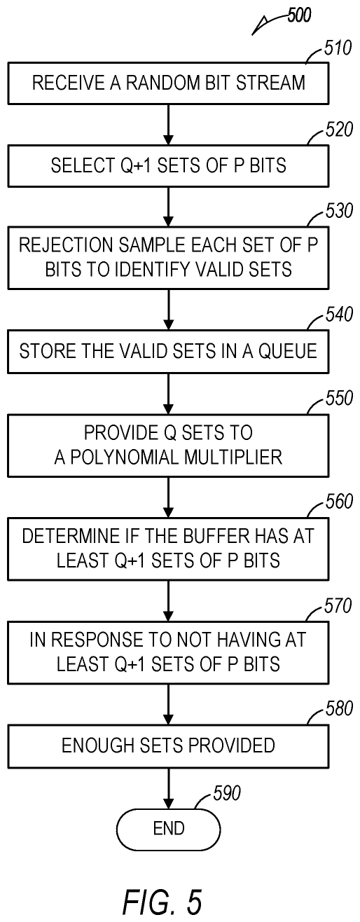

FIG. 5 is a flowchart illustrating a method 500 of validity checking coefficients. Method 500 begins at operation 510 by receiving a random bit string. The random bit string may be generated by a random number generator, such as a Keccak random number generator. The random bit string may be stored in a buffer.

n+1 sets of p bits are selected from the random bit string at operation 520 stored in the buffer. Rejection sampling of each set of p bits is performed at operation 530 to identify valid sets of the p bits. Operation 540 stores the valid sets in a queue. n sets are provided from the stored valid sets to a polynomial multiplier. In one example, n=4 and p=24. If n valid sets are stored in the queue, n sets are provided to a polynomial multiplier at operation 550. Method 500 may iterate over successive n+1 sets of p bits of the random bit string.

A fullness of the buffer 120 may be tracked. At operation 560 it is determined if the buffer 120 has at least n+1 sets of p bits. At decision operation 570, in response to the buffer 120 not having at least n+1 sets of p bits, control returns to operation 510 to receive a next set of candidate coefficients from buffer 120. Otherwise, a check is made to see if enough sets have been provided at 580. If no, control is returned to operation 520 to select a next n+1 sets of p bits. If yes, method 500 ends at operation 590. Method 500 may be repeated for each polynomial with different seeds and nonce values provided as desired.

In one example, the queue in which valid sets of p bits are stored, has a length greater than n, such as 2*n. A fullness of the queue may be tracked. In response to the queue being full, method 500 delays selecting of a next n+1 sets at operation 520 until the queue is not full.

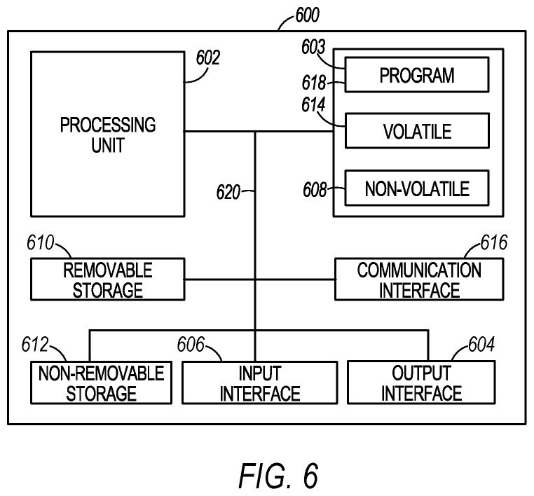

FIG. 6 is a block schematic diagram of a computer system for use in implementing controller 240 and other components of system 100, as well as for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 along with the workspace manager 622 may be used to cause processing unit 602 to perform one or more methods or algorithms described herein.

### Examples

1. A method includes receiving a random bit string, selecting n+1 sets of p bits of the random bit string, where n is an integer having a value of at least four, rejection sampling each set of p bits in parallel to identify valid sets of p bits, storing the valid sets of p bits in a queue, and providing n sets of p bits of the stored valid sets of p bits from the queue to a polynomial multiplier.

2. The method of example 1 where n=4 and p=24, and wherein the rejection sampling ensures that each set of p bits is less than a selected prime number.

3 The method of any of examples 1-2 wherein the received random bit string is generated by a Keccak random number generator.

4. The method of example 1 and further including buffering the random bit string in a buffer, wherein the sets of p bits are selected from the buffer.

5. The method of example 4 and further including determining if the buffer has at least n+1 sets of p bits and in response to the buffer not having at least n+1 sets of p bits, receiving a next random bit string.

6. The method of any of examples 1-5 wherein the queue has a length greater than n.

7. The method of example 6 wherein the queue length is 2*n.

8. The method of any of examples 1-7 wherein the selecting, rejection sampling, buffering, and providing are repeated for successive n+1 sets of p bits of the random bit string.

9. The method of example 8 and further including tracking a fullness of the queue.

10. The method of example 9 and further including in response to the queue being full, delaying selecting of a next n+1 sets until the queue is not full.

11. A polynomial coefficient generator includes a random number generator to generate a random bit string, a buffer coupled to receive bits of the random bit string, a rejection sampler coupled to the buffer to receive n+1 sets of p bits of buffered bits of the random bit string, where n is an integer having a value of at least four, and sample each set of n bits in parallel to identify valid sets of p bits, a valid coefficient queue coupled to receive the valid sets of p bits, and a polynomial multiplier coupled to receive the valid sets of p bits from the valid coefficient queue.

12. The generator of example 11 where n=4 and p=24.

13. The generator of any of examples 11-12 wherein the random number generator is a Keccak random number generator.

14. The generator of any of examples 11-13 and further including a controller configured to determine if the buffer has at least n+1 sets of p bits and in response to the buffer not having at least n+1 sets of p bits, cause the random number generator to provide additional bits of the random bit string to the buffer.

15. The generator of any of examples 11-14 wherein the queue has a length greater than n.

16. The generator of example 15 wherein the queue length is 2*n.

17. The generator of any of examples 11-16 and further including a controller configured to cause the generator to iterate over successive n+1 sets of p bits of the random bit string.

18. The generator of example 17 wherein the controller tracks a fullness of the queue.

19. The generator of example 18 wherein the controller, in response to the queue being full, delays rejection sampler from receiving a next q+1 sets until the queue is not full.

20. A hardware implemented method including receiving a random bit string, storing the random bit string in a buffer, selecting n+1 sets of p bits from the buffer where q is an integer having a value of at least four, rejection sampling each set of p bits in parallel to identify valid sets of p bits, storing the valid sets of p bits in a queue, and providing n sets of p bits of the stored valid sets of p bits from the queue to a polynomial multiplier.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving a random bit string;
selecting n+1 sets of p bits of the random bit string, where n is an integer having a value of at least four;
rejection sampling each set of p bits in parallel to identify valid sets of p bits;
storing the valid sets of p bits in a queue; and
providing n sets of p bits of the stored valid sets of p bits from the queue to a polynomial multiplier.

2. The method of claim 1 where n=4 and p=24, and wherein the rejection sampling ensures that each set of p bits is less than a selected prime number.

3. The method of claim 1 wherein the received random bit string is generated by a Keccak random number generator.

4. The method of claim 1 and further comprising buffering the random bit string in a buffer, wherein the sets of p bits are selected from the buffer.

5. The method of claim 4 and further comprising:
determining if the buffer has at least n+1 sets of p bits; and
in response to the buffer not having at least n+1 sets of p bits, receiving a next random bit string.

6. The method of claim 1 wherein the queue has a length greater than n.

7. The method of claim 6 wherein the queue length is 2*n.

8. The method of claim 1 wherein the selecting, rejection sampling, buffering, and providing are repeated for successive n+1 sets of p bits of the random bit string.

9. The method of claim 8 and further comprising tracking a fullness of the queue.

10. The method of claim 9 and further comprising in response to the queue being full, delaying selecting of a next n+1 sets until the queue is not full.

11. A polynomial coefficient generator comprising:
a random number generator to generate a random bit string;
a buffer coupled to receive bits of the random bit string;
a rejection sampler coupled to the buffer to receive n+1 sets of p bits of buffered bits of the random bit string, where n is an integer having a value of at least four, and sample each set of n bits in parallel to identify valid sets of p bits;
a valid coefficient queue coupled to receive the valid sets of p bits; and
a polynomial multiplier coupled to receive the valid sets of p bits from the valid coefficient queue.

12. The generator of claim 11 where n=4 and p=24.

13. The generator of claim 11 wherein the random number generator is a Keccak random number generator.

14. The generator of claim 11 and further comprising a controller configured to:
determine if the buffer has at least n+1 sets of p bits; and
in response to the buffer not having at least n+1 sets of p bits, cause the random number generator to provide additional bits of the random bit string to the buffer.

15. The generator of claim 11 wherein the queue has a length greater than n.

16. The generator of claim 15 wherein the queue length is 2*n.

17. The generator of claim 11 and further comprising a controller configured to cause the generator to iterate over successive n+1 sets of p bits of the random bit string.

18. The generator of claim 17 wherein the controller tracks a fullness of the queue.

19. The generator of claim 18 wherein the controller, in response to the queue being full, delays rejection sampler from receiving a next q+1 sets until the queue is not full.

20. A hardware implemented method comprising:
receiving a random bit string;
storing the random bit string in a buffer;
selecting n+1 sets of p bits from the buffer where q is an integer having a value of at least four;
rejection sampling each set of p bits in parallel to identify valid sets of p bits;
storing the valid sets of p bits in a queue; and
providing n sets of p bits of the stored valid sets of p bits from the queue to a polynomial multiplier.
